(19) United States
(12) Patent Application Publication
(10) Pub. No.: US 2009/0156166 A1
(43) Pub. Date: Jun. 18, 2009

(54) Telecommunication System Comprising a Plurality of Portable Telephone Sets

(75) Inventor: Henk-Jan Van Der Weide, Almelo (NL)

Correspondence Address: THE WEBB LAW FIRM, P.C., 700 KOPPERS BUILDING, 436 SEVENTH AVENUE, PITTSBURGH, PA, 15219, US

(73) Assignee: HJ VAN DER WEIDE BEHEER B.V., Almelo (NL)

(21) Appl. No.: 11/995,375

(22) PCT Filed: Jul. 12, 2006
(86) PCT No.: PCT/NL06/50174

§ 371 Date: Jul. 23, 2008

(30) Foreign Application Priority Data
Jul. 12, 2005 (NL) 1029494

(51) Int. Cl. H04W 12/00; H04W 4/14

(52) U.S. Cl. 455/411; 455/466

(57) ABSTRACT

A telecommunication system comprises: a computer system; transmitter/receiver units; and wireless telephones which are used by users, and comprise means for sending and receiving SMS and/or MMS messages to and from a selected user via the computer system. The computer system comprises: a memory for messages; access means with which a user gains access to the memory; and identification means which assign a code and send this code to the relevant telephone, wherein the access means are released by the user sending this code to an allocated phone number, wherein: after sending the code for the first time, messages addressed to the user are stored in the memory and blocked from transmission; and by sending the code for the second and subsequent times, all messages stored in the memory are sent to the user.

The invention relates to a telecommunication system with

a fixedly disposed central computer system operated by a provider;

a network of distributed transmitter/receiver units connected to this computer system, and

a number of wireless telephones, for instance of the GSM or UMTS type, which are in the possession of and are used by users, and comprise means for sending and receiving SMS and/or MMS messages to and from a selected user via the computer system.

Such a telecommunication system is known.

SMS and MMS are services on the basis of “push”. This means that the receiver receives the messages sent to him/her unconditionally.

Such messages are often received at a moment or in a situation perceived by a user as being inconvenient or otherwise unwelcome. When a message is received, the recipient mobile telephone usually generates an acoustic signal as well as a visual signal, this being perceived as irritating in for instance a quiet environment, during a concert or the like. Conditions can further occur in which the mobile phone of a user is also accessible to third parties. When an SMS or MMS is received it is then not possible to prevent these third parties gaining access to the possibly confidential information available in the relevant message. This can be highly annoying for a user.

In view of the foregoing, the invention has for its object to provide a telecommunication system of the stated type, which provides the option of a user activating a service provided by the provider via said computer, whereby SMS and MMS messages are stored from a point in time chosen by the user and are only forwarded to him/her at a second point in time chosen by him/her. In this way the user has the option of activating said service at the start of a situation in which the forwarding of messages is undesired, and of deactivating the service at the moment that the user wishes to receive the possibly stored messages.

This object according to the invention is realized with a telecommunication system which has the feature that the computer system comprises:

a memory in which said messages can be stored and from which said messages can be retrieved and read in order to be fed to said network such that the relevant user can receive them;

access means which can be controlled by a user by means of his/her mobile phone such that the relevant user gains access to the memory; and

identification means which assign a personal code (PIN) to a user at the request of this user, and which send this code by SMS to the mobile phone of the relevant user, wherein the access means are released by this user sending an SMS with this code to a specifically allocated phone number, wherein

(1) after sending an SMS with the assigned code for the first time, SMS and MMS messages addressed to the mobile phone of the relevant user are stored in the memory and are blocked from transmission via the network; and

(2) by sending an SMS with the assigned code for the second and subsequent times, all messages stored in the memory are sent to the mobile phone of the relevant user and erased from the memory.

A telecommunication system is known from GB-A-2 404 301 which provides the option of downloading SMS messages by means of a remote control. For this purpose the user must subscribe to the service in question. The server saves copies of all SMS messages not yet read by the subscriber. The subscriber can download SMS messages by means of another phone without first having to return to his/her ‘home’ telephone for this purpose. In order to make use of the service in question the user must communicate to the system an authorization code assigned to him/her. The ‘home’ telephone can be a mobile phone.

EP-A-1 255 414 relates to a system configuration wherein use is made of sensing an SMS message to a message receiver. This can for instance be a wireless telephone. Use is made of a central management system which controls transmission of and reply to SMS messages. The system provides automatic reply to SMS messages. As an example, this specification refers to the sending of a message that the relevant subscriber is on holiday. In order to activate the service the user must enter a determined code assigned to him/her.

The prior art briefly described above does not state that the user can activate and deactivate a central storage service for SMS and MMS messages by transmitting a specific PIN code, as according to the invention.

In a specific embodiment the telecommunication system according to the invention has the feature that the memory comprises selection means which can be controlled by a user by means of his/her mobile phone such that he/she can store numbers of selected mobile phones in the selection means, whereby the storing of messages in the memory respectively retrieving and reading messages from the memory takes place only in respect of messages which are received from the relevant selected mobile phones. In this case the user activates the service offered by the provider via the computer system of the latter only for selected numbers.

In yet another embodiment the telecommunication system according to the invention has the special feature that the memory comprises a timer which controls the memory after a message has been stored therein such that the memory saves this message for a chosen period of time entered in the timer, for instance 21 days, and then erases it. This avoids the central computer of the provider becoming congested with an unnecessarily large number of SMS and MMS messages. This option assumes that after some time, for instance the stated three weeks, the topicality of the information in question is lost and that the user clearly does not set great store by receiving the messages from the preceding period.

In order to make the accessibility of the service as easy as possible for every user, an embodiment is recommended in which the assigned telephone number is the telephone number of the mobile phone of the relevant user. In this manner it is not necessary for the user to enter a specific telephone number in the number memory of his/her mobile telephone or to remember a number. It is assumed in this respect that everyone knows their own telephone number.

According to another aspect of the invention, the telecommunication system has the special feature that, when said code is assigned at the request of the user, the identification means if necessary also modify the relevant settings of the mobile phone of the user.

Such a modification of the settings is also generally usual for other services and is transmitted via an SMS and communicated to the recipient in the usual manner in the form of an SMS.

According to a final aspect of the invention, the telecommunication system has the special feature that the access means for a user can be controlled via the website of the provider.

The service according to the invention requires that the provider installs a relevant application in the central computer system. This application can consist of a database with the relevant telephone numbers and the associated messages coupled thereto. These messages remain retrievable for a predetermined period, for instance 21 days. The sender of an SMS or MMS must however pay the costs of the SMS messages sent by him and temporarily blocked by the recipient, even in the case the service is activated.

The provider preferably makes available a website also allowing retrieval and modification of the settings relating to the service via the web.

As already noted above, when the message blocking service in question is activated the user receives an SMS which adjusts the settings of his/her mobile phone to this service. If the mobile phone is not known, the changes in the settings can only be carried out via the web.

According to a specific aspect of the invention, the telecommunication system has the special feature that a user can specify numbers of mobile phones to the selection means by means of a second code (PIN) assigned to him/her, whereafter SMS and MMS messages originating from those mobile telephones are not stored in the memory and are thus not sent to the user when messages stored in the memory are retrieved by him/her.

According to a specific aspect of the invention, the telecommunication system comprises blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

The invention can be very briefly summarized as follows. The user gains access to a service provided by the provider by activating thereof by means of an SMS which is sent to the computer system by his/her mobile telephone. In the menu of the mobile telephone the user can block all incoming SMS and MMS messages or messages coming from selected numbers temporarily or permanently (until further notice). By sending an assigned code (PIN), which the user receives upon activation, to the provider by means of an SMS, all SMS and MMS messages stored in the memory are forwarded to the user, except the messages coming from senders mentioned on the list of numbers to be definitively blocked, as given to the provider by the user. Such messages are neither stored in the memory nor forwarded to the user directly or upon request.

1. A telecommunication system with
a fixedly disposed central computer system operated by a provider;
a network of distributed transmitter/receiver units connected to this computer system, and
a number of wireless telephones, for instance of the GSM or UMTS type, which are in the possession of and are used by users, and comprise means for sending and receiving SMS and/or MMS messages to and from a selected user via the computer system,
wherein
the computer system comprises:
a memory in which said messages can be stored and from which said messages can be retrieved and read in order to be fed to said network such that the relevant user can receive them;
access means which can be controlled by a user by means of his/her mobile phone such that the relevant user gains access to the memory; and
identification means which assign a personal code (PIN) to a user at the request of this user, and which send this code by SMS to the mobile phone of the relevant user, wherein the access means are released by this user sending an SMS with this code to a specifically allocated phone number, wherein
(1) after sending an SMS with the assigned code for the first time, SMS and MMS messages addressed to the mobile phone of the relevant user are stored in the memory and are blocked from transmission via the network; and
(2) by sending an SMS with the assigned code for the second and subsequent times, all messages stored in the memory are sent to the mobile phone of the relevant user and erased from the memory.

2. The telecommunication system as claimed in claim 1, wherein the memory comprises selection means which can be controlled by a user by means of his/her mobile phone such that he/she can store numbers of selected mobile phones in the selection means, whereby the storing of messages in the memory respectively retrieving and reading messages from the memory takes place only in respect of messages which are received from the relevant selected mobile phones.

3. The telecommunication system as claimed in claim 1, wherein the memory comprises a timer which controls the memory after a message has been stored therein such that the memory saves this message for a chosen period of time entered in the timer, for instance 21 days, and then erases it.

4. The telecommunication system as claimed in claim 1, wherein the assigned telephone number is the telephone number of the mobile phone of the relevant user.

5. The telecommunication system as claimed in claim 1, wherein, when said code is assigned at the request of the user, the identification means if necessary also modify the relevant settings of the mobile phone of the user.

6. The telecommunication system as claimed in claim 1, wherein the access means for a user can be controlled via the website of the provider.

7. The telecommunication system as claimed in claim 2, wherein a user can specify numbers of mobile phones to the selection means by means of a second code (PIN) assigned to him/her, whereafter SMS and MMS messages originating from those mobile telephones are not stored in the memory, and are thus not sent to the user when messages stored in the memory are retrieved by him/her.

8. The telecommunication system as claimed in claim 1, further comprising blocking means with which a user can send a message to the computer system by means of his/her mobile phone, as a result of which the computer system is adjusted such that a third party, who sends an SMS or MS message by means of his/her mobile phone to the mobile phone of said user, receives a reply on his/her mobile phone which shows that the mobile telephone of said user is switched off or is out of reach of the network.

9. The telecommunication system as claimed in claim 2, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

10. The telecommunication system as claimed in claim 3, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

11. The telecommunication system as claimed in claim 4, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

12. The telecommunication system as claimed in claim 5, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

13. The telecommunication system as claimed in claim 6, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.

14. The telecommunication system as claimed in claim 7, further comprising blocking means with which a user can send a message to the computer system by means of his/her mobile phone, as a result of which the computer system is adjusted such that a third party, who sends an SMS or MMS message by means of his/her mobile phone to the mobile phone of said user, receives a reply on his/her mobile phone which shows that the mobile telephone of said user is switched off or is out of reach of the network.
